(19) United States
(12) Patent Application Publication
(10) Pub. No.: US 2004/0222196 A1
(43) Pub. Date: Nov. 11, 2004

(54) Device for laser drilling

(76) Inventors: Gert Callies, Buehl (DE); Tilmann Schmidt-Sandte, Stuttgart (DE); Thomas Wawra, Boehmenkirck (DE)

Correspondence Address: KENYON & KENYON, ONE BROADWAY, NEW YORK, NY, 10004, US

(21) Appl. No.: 10/798,116

(22) Filed: Mar. 10, 2004

(30) Foreign Application Priority Data
Mar. 10, 2003 (DE) 10310293.0

(51) Int. Cl. B23K 26/38

(52) U.S. Cl. 219/121.7; 219/121.71

(57) ABSTRACT

A device and a method for optimizing laser drilling and laser erosion. An electrode is situated opposite a workpiece to be processed. A current-voltage source is interconnected in such a way that an electric field is applied between the workpiece and the electrode, the workpiece being positively charged and the electrode being negatively charged. By acting upon a point of action on the workpiece, a laser beam causes the material erosion. Metal ions and/or plasma ions created in the proximity of the point of action are positively charged. They are accelerated in the direction of the electrode, so that they are removed from the point of action.

### FIELD OF THE INVENTION

The present invention relates to a method for laser drilling and a corresponding device.

### BACKGROUND INFORMATION

High laser beam intensities are generally used in laser drilling or erosion processes via laser to pulse-wise vaporize material in a spot to be machined. Due to these high intensities, a plasma may be produced above the spot to be machined. The strength of the plasma (density and size) depends on the atmosphere, the laser wavelength, and the intensity of the laser radiation. The higher the intensity, the stronger the plasma produced. The atmospheric condition depends on the ambient conditions, in particular the process gas and the material particles being removed. The laser beam is influenced by the interaction with the plasma. Energy, which is no longer available for the actual erosion, is absorbed by the plasma. In addition, the laser beam is reflected on the plasma, which deteriorates the quality of the laser beam. The laser beam is decomposed into filaments or it experiences an unfavorable global directional change. In ultra-short-pulse laser drilling, in particular, this results in a deterioration of the processing quality, which is to be understood as being eccentricities and breakout of the drilling at the exit side of a drilling hole. Furthermore, slanted drilling may result, i.e., the drilling axis deviates from the laser beam axis.

To prevent these effects, or to reduce them, one could reduce the intensity of the laser pulses, for example. However, this results in long processing times. Moreover, one could work with a lower-density process gas or one could work in partial vacuum. A measure yielding additional advantages in this regard would be drilling in a vacuum.

An object of the present invention is to provide a device and a method for laser drilling and laser erosion, in particular with short pulse lengths (fs/ps/ns), which reduces the vapor of material above the point of action of the laser beam.

### SUMMARY OF THE INVENTION

The method according to the present invention for laser drilling or laser erosion, in which a laser beam, produced by a laser, is applied to a point of action of a workpiece, is characterized in that the point of action is exposed to an electric field. This method has the advantage that material vapor and/or plasma developing during laser drilling is removed from the area of the point of action.

In a particularly advantageous embodiment, the electric field is produced by applying a voltage to an electrically conductive workpiece and to an electrode situated at some distance from the workpiece. The particles in the material vapor, in particular positively charged ions, are systematically removed from the point of action by the directional electric field. This results in less particles capable of igniting a plasma being present in subsequent laser pulses. Furthermore, the present invention advantageously minimizes decomposition into filaments and deflection of the laser beam caused by plasma or material vapor. This results in improved processing quality, in particular in laser drilling of small drilling diameters. In addition, the repetition rate and thus the processing speed during laser drilling is clearly increased. In the case of an electrically conductive workpiece and suitable polarity of the electric field, metal vapor or material vapor is accelerated toward the electrode which is situated opposite the point of action. Thus, less metal vapor condenses around the spot of material erosion.

In a further embodiment of the present invention, the point of action is exposed to a magnetic field. Such a magnetic field is to a large extent directed perpendicularly to the electric field in particular. This has the advantage that the ions, moving away from the point of action, are additionally deflected sideways due to the Lorentz force acting upon them.

Moreover, a current generated by the electric field applied may be measured. This electric current is caused by the transport of ions from the workpiece to the electrode. An easily remeasurable parameter, which may be used as a variable for the processing safety, is made available in a particularly simple manner. The higher this current, the higher the material's vaporization rate or erosion rate from the workpiece. There is the possibility to measure the erosion rate on-line. A measure for the drilling rate may in turn be derived therefrom.

According to the present invention, in the area of the point of action or between the workpiece and the electrode, an electric alternating field may be generated and its capacitive reactance measured. The capacitive reactance is influenced by ionized material vapor or metal vapor, or by plasma between the workpiece and the electrode which may also be considered two capacitor plates opposite one another. The measurement of the capacitive reactance provides a means for determining the strength of the plasma.

Furthermore, the current-voltage source is designed as a direct current-voltage source. This design makes it possible that a largely static electric field is applied between the workpiece and the electrode during the comparatively short laser pulses in the femtosecond, picosecond, or nanosecond range.

In a further embodiment of the present invention, the workpiece and the electrode are interconnected in such a way that the workpiece is positively charged and the electrode is negatively charged. During erosion using a high-intensity pulsed laser beam, material, metal in particular, is vaporized with each pulse at the point where the workpiece is to be machined. Positive metal ions are created due to the polarity of the electric field according to the present invention. These metal ions and additional positive ions, plasma ions in the atmosphere in particular, are repelled from the positively charged workpiece, and are accelerated toward the negative electrode, away from the point of machining. In an advantageous manner, this results in the density of the material vapor between individual laser pulses being reduced above the point of action of the laser beam.

Moreover, the electrode, having a one-piece design in particular, has at least one opening through which the laser beam passes without obstruction. The size of such an opening is selected according to the requirements. Free propagation of the laser beam onto the point of action of the workpiece is thus ensured and also most positive ions, created at the point of action during laser drilling, are removed by the negative electrode.

### BRIEF DESCRIPTION OF THE DRAWINGS

FIG. 1 shows a schematic sectional view of a preferred embodiment of the device according to the present invention.

FIG. 2 shows a schematic sectional view of a preferred embodiment of the device according to the present invention during execution of the method according to the present invention.

### DETAILED DESCRIPTION

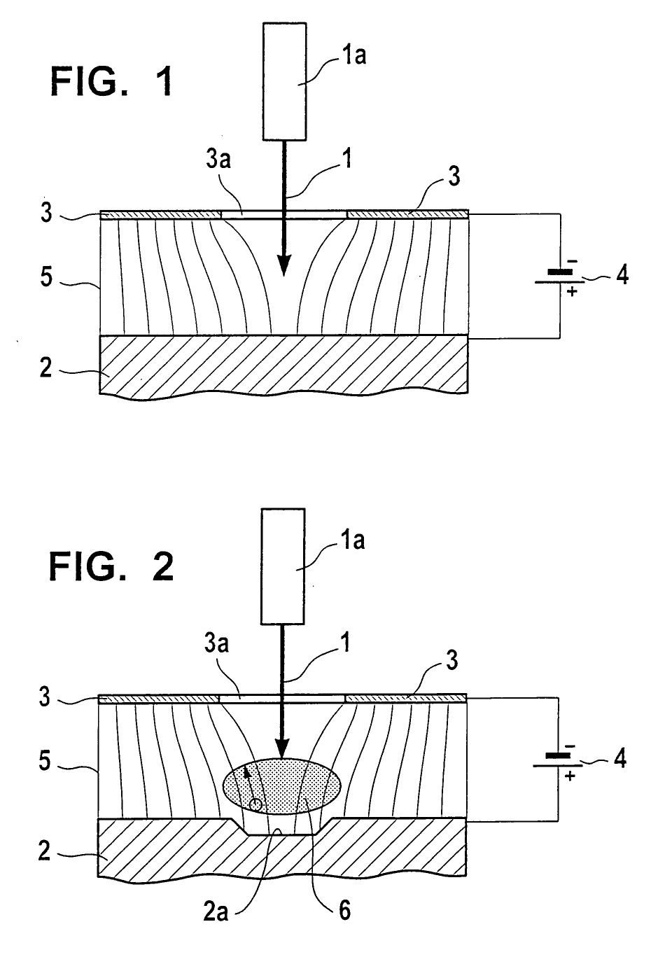

In FIG. 1, an electrode 3 is situated opposite a surface of a metallic workpiece 2. This electrode 3 has an opening 3a through which a laser beam 1, generated by a laser 1a, may pass. The present illustration of the device shows a schematic sectional view of the device through opening 3a of electrode 3. It should be pointed out that electrode 3 has a one-piece design. Workpiece 2 is connected to electrode 3 via a current-voltage source 4. Current-voltage source 4 has a polarity such that workpiece 2 is charged positively and electrode 3 is charged negatively. Electric field 5, applied between workpiece 2 and electrode 3 and generated by current-voltage source 4, is indicated here by dotted lines.

FIG. 2 shows the same device as FIG. 1, material erosion taking place at a point of action 2a due to laser beam 1 acting upon workpiece 2. A cloud of metal ions and/or plasma ions 6 formed here is illustrated in FIG. 2 by an oval-shaped dotted area. Due to the fact that workpiece 2 is charged positively, metal ions and/or plasma ions 6, which are produced at point of action 2a due to the material erosion caused by laser beam 1, are charged positively. Due to the electromagnetic interaction, these ions are repelled from workpiece 2, accelerated by electric field 5, and pulled toward electrode 3. The required physical basics are illustrated in Table 1.

| | | |
|---|---|---|
| Acceleration a of the ions in the electric field | $a = \frac{e}{m} \cdot \frac{U}{d}$ | Elementary charge e and mass m of the ions, electrode voltage U and distance d between the electrodes |
| Number of particles n (general gas law) | $n = \frac{P}{k} \cdot T$ | Pressure p, Boltzmann constant k, and temperature T |
| Thermal velocity Vₜₕ | ${v}_{th} = \sqrt{\frac{3 k T}{m}}$ | see above |
| Drift velocity v of the ions in the atmosphere | $v = \frac{U}{d} \cdot \frac{e}{2 m \cdot {v}_{th} \cdot n \cdot A}$ | With impact cross section A of the ions |

In an electric field 5 which is generated, for example, by a voltage of U=1,000 volts and a distance of 5 mm between workpiece 2 and electrode 3, drift velocities of approximately 60 m/s result for Fe ions for a normal atmosphere at room temperature. Due to high pressures and high temperatures in the plasma, the actual drift velocity will be lower by several orders of magnitude. Depending on the application, the technical design of electrode 3 can be optimized, so that an electric field 5, which is as high as possible, is generated in the area of action of laser beam 1.

During execution of the method according to the present invention, very high vapor pressures, high temperatures, and thus high accelerations of the material particles, i.e., metal and/or plasma ions 6 away from the workpiece, are generated by the laser pulse. The accelerations and resulting velocities are thus to be higher than the ones caused only by an electric field 5. The vapor pressure and the temperature dissipate very rapidly after a laser pulse, so that the influence of the electric field predominates. The influence of the electric field during the laser pulse is small. The pulse length in the femtosecond or picosecond range is small compared to the time between two laser pulses in the millisecond range. Thus, the decisive effect of electric field 5 occurs primarily between the laser pulses.

Metallic particles or plasma ions inevitably occur in laser drilling and interfere with laser drilling. By using the device according to the present invention it is now possible to remove these metallic particles or plasma ions from the area to be machined or the point of action of the laser beam, thus optimizing laser drilling and laser erosion.

What is claimed is:

1. A method for laser drilling and laser erosion, the method comprising:
using a laser, generating a laser beam acting upon a point of action on a workpiece; and
exposing the point of action to an electric field.

2. The method according to claim 1, further comprising generating the electric field by applying a voltage to an electrically conductive workpiece and an electrode which is situated at a distance from the point of action.

3. The method according to claim 1, wherein the electric field has a polarity such that positively charged ions are accelerated away from the workpiece by the electric field.

4. The method according to claim 1, further comprising exposing the point of action to a magnetic field.

5. The method according to claim 1, further comprising measuring a current generated by the electric field applied.

6. The method according to claim 1, further comprising, one of (a) in an area of the point of action and (b) between the workpiece and an electrode, generating an alternating electric field and measuring its capacitive resistance.

7. The method according to claim 1, further comprising eliminating at least one of material vapor and plasma which are formed during laser drilling/laser erosion.

8. The method according to claim 1, wherein the method is used for process safety.

9. A device for laser drilling and laser erosion comprising:
a laser for generating a laser beam acting upon a point of action on a workpiece; and
a device for generating an electric field in an area of the point of action.

10. The device according to claim 9, wherein the device for generating an electric field includes an electrode and a current-voltage source, the electrode being situated at a distance from the point of action, the current-voltage source being interconnected between an electrically conductive workpiece and the electrode in such a way that the electric field is applied between the workpiece and the electrode.

11. The device according to claim 10, wherein the current-voltage source is a direct current-voltage source.

12. The device according to claim 10, wherein the workpiece and the electrode are interconnected in such a way that the workpiece is positively charged and the electrode is negatively charged.

13. The device according to claim 9, wherein a magnetic field is applied in an area of the point of action on the workpiece.

14. The device according to claim 10, further comprising an electric measuring device for measuring a current flowing between the workpiece and the electrode.

15. The device according to claim 10, wherein the current-voltage source generates a high-frequency alternating voltage, and further comprising a measuring device for measuring a capacitive resistance between the workpiece and the electrode.

16. The device according to claim 10, wherein the electrode has a one-piece design and has at least one opening through which the laser beam passes without obstruction.
